(19) United States
(12) Patent Application Publication
(10) Pub. No.: US 2019/0007355 A1
(43) Pub. Date: Jan. 3, 2019

(54) COMMUNICATING WITH CLIENT DEVICES USING OVER-THE-TOP COMMUNICATION CHANNELS

(71) Applicant: salesforce.com, inc., San Francisco, CA (US)

(72) Inventor: Eugene Lew, Olney, MD (US)

(21) Appl. No.: 16/020,926

(22) Filed: Jun. 27, 2018

Related U.S. Application Data
(60) Provisional application No. 62/526,844, filed on Jun. 29, 2017.

(51) Int. Cl. H04L 12/58; H04L 29/06; H04L 12/18

(52) U.S. Cl. CPC H04L 51/066; H04L 65/1069; H04L 51/28; H04L 51/38; H04L 12/185; H04L 51/14; H04L 51/046

(57) ABSTRACT

An online system allows client devices to communicate via over-the-top (OTT) messaging channels. The client devices may not be coupled via a particular OTT messaging channel. The online system also allows a client device to communicate via an OTT channel with another client device that uses a non-OTT channel. The online system receives a request from a first client device via an OTT channel and establishes a connection with the client device via the OTT messaging channel. The online system allows the client device to communicate with another client device by establishing a connection with the other client device. The connection with the second client device may be established via a different OTT messaging channel or via a non-OTT messaging channel. The online system may be a multi-tenant system that allows client devices of users to connect with client devices of enterprises that are tenants of the multi-tenant system.

### CROSS-REFERENCE TO RELATED APPLICATION(S)

This application claims the benefit of U.S. Provisional Application No. 62/526,844, filed Jun. 29, 2017, which is incorporated by reference in its entirety.

### BACKGROUND

Messaging channels are used as a means of communication between devices, for example, mobile phones, tablets, or laptops. Client devices communicate with each other via a messaging channel using a messaging application that executes on the client device or via the network cloud with a general purpose network cloud interface application (e.g. —Internet browser). The client application provides a user interface that allows the client device to establish a connection with another client device via the messaging channel and to communicate with the other client device. Messaging channels may allow users to communicate using text, audio, video, or images. An OTT messaging channel is built over the network services of a service provider. Each messaging channel may use a different protocol/code/format. For example, different messaging channels provided by different vendors typically use different protocols/codes/formats. However, conventional techniques require that client devices that communicate using an OTT messaging channel are required to be coupled via the particular OTT messaging channel. For example, the client devices follow a particular protocol of the OTT messaging channels to exchange information required to be able to establish a connection via the OTT messaging channel. This may cause problems if a particular client device is used to communicate with several other client devices, for example, if several users associated with an organization communicate with an agent of an organization. Different client devices of users may use different OTT messaging channels and the client device of the agent may not be coupled with each of the user via the OTT messaging channel. Furthermore, since several OTT messaging channels are being developed, the client device of the agent may not even have installed the messaging applications of all the messaging OTT messaging channels that various users may use.

### BRIEF DESCRIPTION OF THE DRAWINGS

FIG. 1 is block diagram of a system environment in which an online system operates, in accordance with an embodiment.

FIG. 2 is a block diagram illustrating the system architecture of an online system, in accordance with an embodiment.

FIG. 3A is a diagram illustrating a lookup table for identifying an enterprise, in accordance with an embodiment.

FIG. 3B is a diagram illustrating a lookup table for establishing a connection with the identified enterprise of FIG. 3A, in accordance with an embodiment.

FIG. 4 is a flowchart illustrating a method for establishing a connection between a first client device and a second client device using OTT messaging channels, in accordance with an embodiment.

FIG. 5 is a flowchart illustrating a method for communication between a first client device and a second client device using OTT messaging channels, in accordance with an embodiment.

FIG. 6 is a high-level block diagram illustrating an example computer for implementing the client device and/or the multi-tenant system or online system of FIG. 1, according to an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview

Embodiments relate to a communication with client devices using a messaging channel, for example, an OTT messaging channel based on OTT message providers. An online system allows communications between two or more client devices. Each of the client devices may communicate via an OTT messaging channel. In some embodiments, one or more of the client devices that are communicating use non-OTT messaging channels to communicate with OTT messaging channels. Client devices use messaging applications to interact with other client devices via messaging channels. Examples of messaging applications including over-the-top (OTT) messaging applications like WHATSAPP, WECHAT, FACEBOOK MESSENGER, APPLE IMESSAGE, GOOGLE HANGOUT, and the like. Examples of non-OTT messaging channels is legacy text messaging services offered by mobile network providers, for example, SMS (short message service) or MMS (multimedia messaging service) messaging channels.

An online system allows communications between client devices using OTT messaging channels or between client devices using OTT messaging services with client devices using non-OTT services. For example, a multi-tenant system stores data for enterprises, each enterprise representing a tenant of the multi-tenant system. The multi-tenant system allows client devices of users to communicate with client devices of agents of the enterprises via OTT messaging channels. However, the techniques disclosed are not limited to multi-tenant systems and can be implemented using any online system that allows communications between two client devices using OTT messaging channels.

The online system allows two client devices to communicate even if one of the client devices uses an OTT messaging channel that is different from the OTT messaging channel used by the other client device. The online system allows two client devices to communicate even if one of the client devices uses an OTT messaging channel and the other client device uses a non-OTT messaging channel. Two client devices can communicate with each other via an online system even if they are not connected coupled with each other via the same OTT messaging channel. Two client devices are coupled via an OTT messaging channel by following a protocol of the OTT messaging channel that allows the two client devices to exchange information that allows the client devices to establish a session using the OTT messaging channel. For example, the client devices may exchange phone numbers to be able to communicate via a particular OTT messaging channel. As another example, the client devices may exchange email addresses to be able to communicate via another OTT messaging channel. Furthermore, both client devices that communicate via an OTT messaging channel must install and execute an OTT messaging application that executes the instructions that implement communication protocols of the OTT messaging channel. However, embodiments of the invention allow two client devices to communicate even if they do not have the same OTT messaging application or if one of the client device uses a non-OTT messaging channel. Accordingly, the online system allows an OTT messaging application for OTT messaging channel C1 executing on a first client device to communicate with an OTT messaging application for OTT messaging channel C2 executing on a second client device. The OTT messaging application for OTT messaging channel C1 executing on a first client device uses the protocols of the OTT messaging channel C1 while communicating with the second client device that uses the protocols of the OTT messaging channel C2.

According to an embodiment, the online system receives a request from a first client device via a first over-the-top (OTT) channel, the request includes an identifier (ID) associated with a user of a second client device. The online system creates a first connection via the first OTT messaging channel with the first client device. The online system accesses a set of connection parameters for the second OTT messaging channel and creates a second connection via the second OTT messaging channel with a second client device associated with the enterprise system. The online system performs communications between the first client device and the second device.

The online system performs communications between the first client device and the second device by performing the following steps. The online system receives a first message from the first client device via the first OTT messaging channel, converts the first message to a message conforming to the second OTT messaging channel, and sends the converted first message via the second OTT messaging channel to the second client device. Furthermore, the online system receives a second message from the second client device via the second OTT messaging channel, converts the second message to a message conforming to the first OTT messaging channel, and sends the converted second message via the first OTT messaging channel to the first client device. The online system may repeat these steps.

In an embodiment, the online system allows an OTT messaging application for OTT messaging channel C1 executing on a first client device to communicate with a non-OTT messaging application for OTT messaging channel C3 executing on a second client device. The OTT messaging application for OTT messaging channel C1 executing on a first client device uses the protocols of the OTT messaging channel C1 while communicating with the second client device that uses the protocols of the non-OTT messaging channel C3. The online system performs communications between the first client device and the second device by performing the following steps. The online system receives a first message from the first client device via the first OTT messaging channel, converts the first message to a message conforming to the non-OTT messaging channel, and sends the converted first message via the non-OTT messaging channel to the second client device. Furthermore, the online system receives a second message from the second client device via the non-OTT messaging channel, converts the second message to a message conforming to the first OTT messaging channel, and sends the converted second message via the first OTT messaging channel to the first client device. The online system may repeat these steps.

According to another embodiment, the online system is a multi-tenant system. The multi-tenant system receives a request from a first client device via a first over-the-top (OTT) channel, the request including an enterprise system identifier (ID) for an enterprise that is a tenant of the multi-tenant system. The multi-tenant system creates a first connection via the first OTT messaging channel with the first client device. The multi-tenant system accesses a set of connection parameters for the second OTT messaging channel, the set of connection parameters associated with the enterprise. The multi-tenant system creates a second connection via the second OTT messaging channel with a second client device associated with the enterprise system. The multi-tenant system and performs communications between the first client device and the second device by performing the steps described above for converting messages received from the client devices across OTT messaging channels.

### Overall System Environment

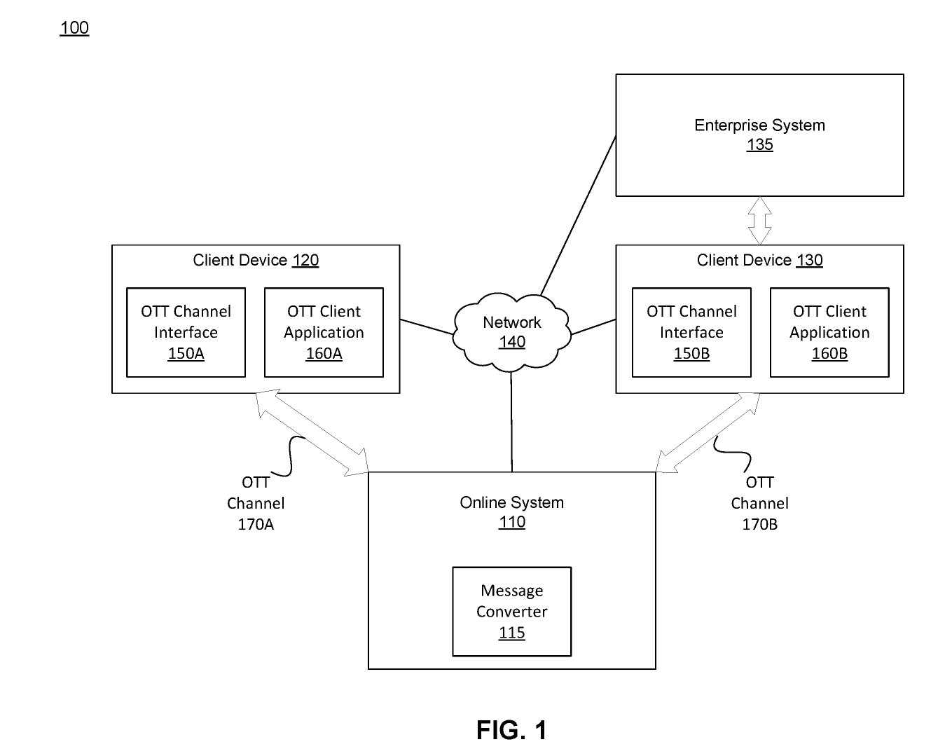

FIG. 1 is block diagram of a system environment 100 in which an online system operates, in accordance with an embodiment. In addition to the online system 110, the system environment 100 includes, among other components, client devices 120 and 130, an enterprise system 135, and a network 140. In alternative configurations, different and/or additional components may be included in the system environment 100.

In one embodiment, the online system is a multi-tenant system such that one client device is associated with an enterprise that is a tenant of the multi-tenant system. For example, client device 130 is used by an agent of the enterprise and another client device is associated with a user, for example, a customer of the enterprise.

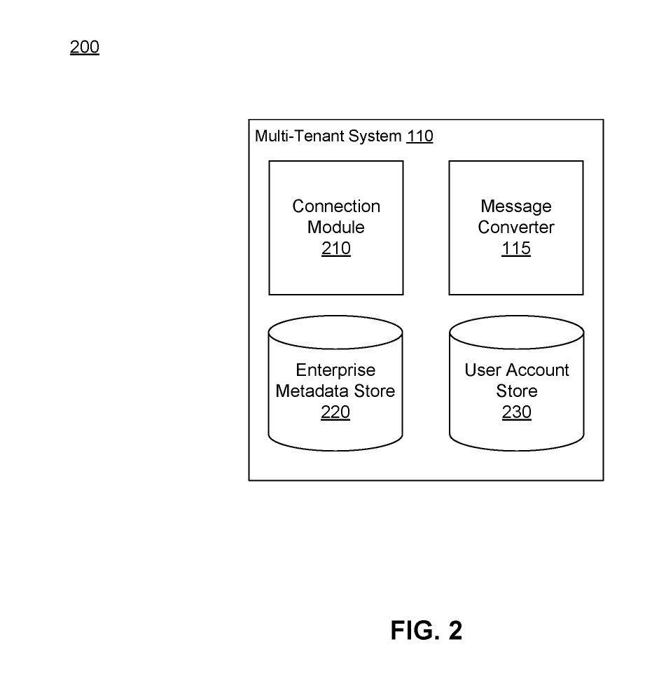

The online system 110 communicates with the client devices 120/130 and the enterprise system 135 via the network 140. The online system 110 interacts with the client device 120 via a first OTT messaging channel 170A. The client device 120 executes the first OTT client application 160A that is used for interacting with the online system 110 via the first OTT messaging channel 170A. The online system 110 interacts with a second client device 130 associated with the enterprise system 135 via a second OTT messaging channel 170B. The second OTT messaging channel 170B interacts with the client device 130 via a second OTT client application 160B. The first and second ITT messaging channels can use different OTT messaging protocols, for example, the first OTT messaging channel 170A may perform text based communications while the second OTT messaging channel 170B performs voice based communications. The online system 110 includes, among other components, a message converter 115. The message converter 115 and other components of the online system 110 are described below with reference to FIG. 2 in detail.

The client device 120 is a computing device capable of receiving user input as well as transmitting and/or receiving data via the first OTT messaging channel 170A. In one embodiment, the client device 120 is a conventional computer system, such as a desktop or a laptop computer. Alternatively, the client device 120 may be a device having computer functionality, such as a personal digital assistant (PDA), a mobile telephone, a smartphone, or another suitable device. The client device 120 is coupled to the network 140 for communicating with the online system 110.

The client device 120 is configured to communicate with the online system 110 via the first OTT messaging channel 170A. Unlike conventional systems, the client device 120 is not directly coupled to the client device 130 via the first OTT messaging channel 170A. In one embodiment, the client device 120 executes an application allowing a user of the client device 120 to interact with the online system 110. For example, the client device 120 executes a first OTT client application 160A such as the user interface of APPLE BUSINESS CHAT or FACEBOOK MESSENGER to enable interaction between the client device 120 and the online system 110 via the first OTT messaging channel 170A. The first OTT messaging channel interface 150A allows for communication with the first OTT messaging channel 170A. An OTT messaging channel interface is a module comprising instructions for various protocols of the corresponding OTT messaging channel, for example, protocols for creating a session with another system (e.g., client device) and protocols for communicating with the system after having established the connection.

In an embodiment, the online system is a multi-tenant system and the client device 130 is associated with the enterprise system 135 representing a tenant of the multi-tenant system. The client device 130 is configured to communicate with the online system 110 via the second OTT messaging channel 170B. The client device 130 executes an OTT client application 160B allowing a user associated with the enterprise system 135 to interact with the multi-tenant system. The client device 130 executes a second OTT client application 160B different from the first OTT client application 160A. The client device 130 also executes a second OTT messaging channel interface 150B that allows for communication via the second OTT messaging channel 170B.

The client devices 120/130 and the enterprise system 135 are configured to interact with the online system 110 via the first OTT messaging channel 170A and the second OTT messaging channel 170B, respectively, which communicate using network 140. The network 140 may comprise any combination of local area and/or wide area networks, using both wired and/or wireless communication systems. In one embodiment, the network 140 uses standard communications technologies and/or protocols. For example, the network 140 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 140 include multiprotocol label switching (MPLS), transmission control protocol/Internet protocol (TCP/IP), hypertext transport protocol (HTTP), simple mail transfer protocol (SMTP), and file transfer protocol (FTP). An OTT messaging channel 170 is bi-directional, which allows for communication in both directions between the client device 120 and the online system 110 or between two client devices.

The first OTT messaging channel 170A may include the first OTT client application 160A executing on the client device 120, wherein the first OTT messaging channel 170A interacts with the online system 110 using a messaging protocol. The second OTT messaging channel 170B may include the second OTT client application 160B executing on the client device 130, wherein the second OTT messaging channel 170B interacts with the online system 110 using a messaging protocol.

In an embodiment, one of the client devices 120 or 130 executed a non-OTT client application and uses a non-OTT messaging interface for communicating. The online system 110 allows the client devices with the non-OTT client application to communicate using the non-OTT messaging interface to communicate with the client device executing the OTT client application and the OTT messaging interface.

Data exchanged over the network 140 may be represented using any suitable format, such as hypertext markup language (HTML), extensible markup language (XML), or represented in JavaScript object notation (JSON). In some embodiments, all or some of the communication links of the network 140 may be encrypted using any suitable technique or techniques.

FIG. 2 is a block diagram 200 of the system architecture of an online system, in accordance with an embodiment. The online system 110 communicates with the client devices 120/130 and the enterprise system 135, as described above with reference to FIG. 1. The online system 110 includes a connection module 210, the message converter 115, an enterprise metadata store 220, and a user account store 230.

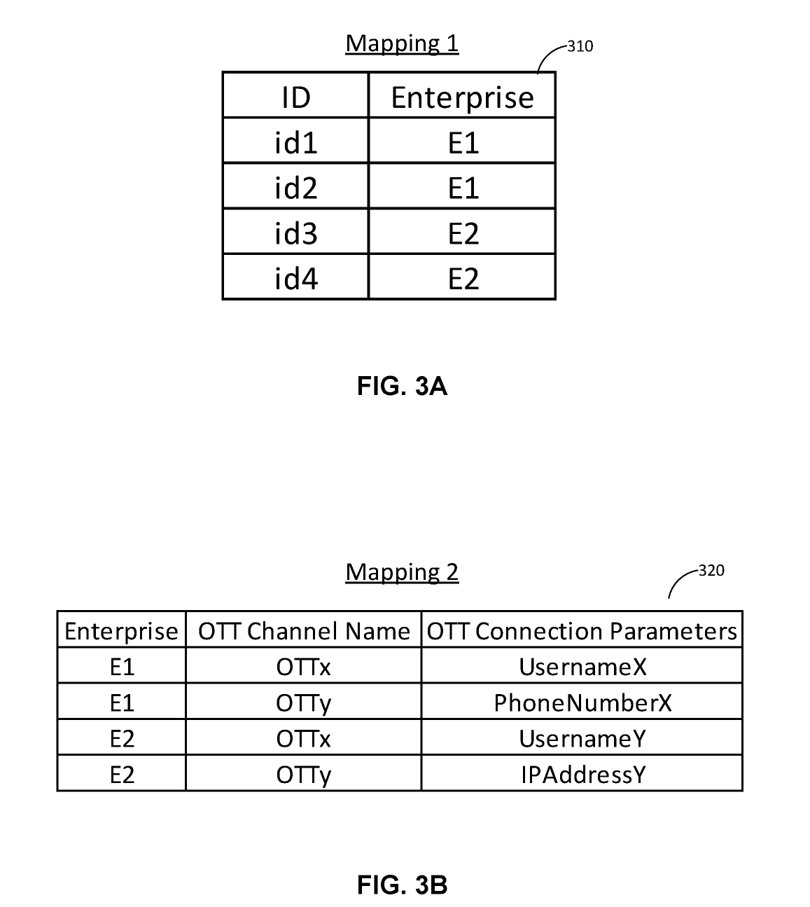

The connection module 210 establishes a connection between the online system 110 and a client device 120/130. The connection module 210 receives a request to establish a connection with a client device and creates a connection with the client device in response. The connection module 210 accesses a set of connection parameters for a second OTT messaging channel, the set of connection parameters associated with the enterprise. In some embodiments, the connection module 210 accesses a second set of connection parameters for a third OTT messaging channel, the second set of connection parameters associated with the enterprise. The set of connection parameters are described below with reference to FIG. 3B.

The message converter 115 converts a first message to a message conforming to the second OTT messaging channel. The message converter 115 further converts a second message to a message conforming to the first OTT messaging channel. This allows for bi-directional communication between the client device and the enterprise. For example, if the client device is executing OTT client application WECHAT and the enterprise system is executing OTT client application FACEBOOK MESSENGER, the online system 110 receives a WECHAT message from the client device and converts the WECHAT message to a FACEBOOK MESSENGER message conforming to the second OTT messaging channel. The online system 110 then receives a FACEBOOK MESSENGER message from the enterprise and converts the FACEBOOK MESSENGER message to a WECHAT message conforming to the first OTT messaging channel. In an embodiment, the message converter 115 performs conversion between OTT messages and non-OTT messages.

The enterprise metadata store 220 stores the set of connection parameters for the OTT messaging channels. In an embodiment, the set of connection parameters is associated with an identifier, for example, an identifier associated with an entity such as an enterprise or a user. For example, an enterprise may use a phone number as an identifier or an email address as an identifier. There may be multiple identifiers for the same entity, for example, an enterprise may provide a phone number, an email address, a uniform resource location (URL), or any unique string for use as an identifier. Any client device using a particular OTT messaging channel can communicate with a client device of the enterprise by using any one of the identifiers, even if the identifier is not used by the OTT messaging channel typically for establishing a connection. For example, a particular OTT messaging channel may use a phone number for establishing a connection. However, embodiments of the invention allow the messaging channel to use an email address to establish the connection or a unique string specified by the enterprise in their website for establishing the connection.

The user account store 230 stores user accounts associated with each user of the online system 110. In one embodiment, a user account store includes multiple data fields, each describing one or more attributes of the corresponding user. Examples of information stored in a user account include biographic, demographic, and other types of descriptive information, such as work experience, educational history, gender, preferences, location and the like. A user account may also store other information provided by the user, for example, a preferred OTT client application or previously used OTT client applications.

In one embodiment, the online system 110 is a multi-tenant system that implements a web-based customer relationship management (CRM) system. For example, in one embodiment, the multi-tenant system includes application servers configured to implement and execute CRM software applications as well as provide related data, code, forms, webpages and other information to and from client devices 120 and to store to, and retrieve from, a database system related data, objects, and webpage content. Various enterprises may be tenants of a multi-tenant system. Each enterprise may have its own enterprise system 135 for running processes and applications that may not be executed by the multi-tenant system. An enterprise representing tenants of a multi-tenant system may have specialized users, for example, agents that represent the enterprise, for example, as customer service representatives. These agents may communicate with users, for example, customers of the enterprise via client devices using OTT messaging channels.

With a multi-tenant system, data for multiple tenants may be stored in the same physical database, however, tenant data typically is arranged so that data of one tenant is kept logically separate from that of other tenants so that one tenant does not have access to another tenant's data, unless such data is expressly shared. In certain embodiments, the multi-tenant system implements applications other than, or in addition to, a CRM application. For example, the multi-tenant system may provide tenant access to multiple hosted (standard and custom) applications, including a CRM application. According to one embodiment, the multi-tenant system is configured to provide webpages, forms, applications, data and media content to client devices to support the access by client devices 110 as tenants of online system 100. As such, the multi-tenant system provides security mechanisms to keep each tenant's data separate unless the data is shared.

A multi-tenant system may implement security protocols that keep data, applications, and application use separate for different tenants. In addition to user-specific data and tenant-specific data, the multi-tenant system may maintain system level data usable by multiple tenants or other data. Such system level data may include industry reports, news, postings, and the like that are shareable among tenants.

It is transparent to users of the tenants that their data may be stored in a table that is shared with data of other customers. A database table may store rows for a plurality of customers. Accordingly, in a multi-tenant system various elements of hardware and software of the system may be shared by one or more customers. For example, the multi-tenant system may execute an application server that simultaneously processes requests for a number of customers.

FIG. 3A is a diagram illustrating a lookup table for identifying an enterprise, in accordance with an embodiment. The lookup table 310 includes an identifier (ID) column and an enterprise column. An identifier of the ID column may be e.g., a phone number, a unique identifier issued by the system, a URL, a unique name, or an address. An enterprise may be associated with one or more identifiers. For example, in the embodiment of FIG. 3A, enterprise E1 is associated with identifiers id1 and id2, and enterprise E2 is associated with identifiers id3 and id4.

FIG. 3B is a diagram illustrating a lookup table for establishing a connection with an enterprise, in accordance with an embodiment. The lookup table 320 includes an enterprise column, an OTT messaging channel name column, and an OTT connection parameters column. OTT connection parameters are parameters used to establish a connection between the multi-tenant system and the enterprise via an OTT messaging channel. For example, if the enterprise is executing OTT client application FACEBOOK MESSENGER, the OTT connection parameters include the username of the enterprise. The multi-tenant system uses the username to establish a connection with the enterprise via an OTT messaging channel associated with FACEBOOK MESSENGER. The OTT connection parameters may further include IP address or phone number, depending on the OTT client application. An enterprise may be associated with one or more OTT messaging channel names and their corresponding OTT connection parameters. For example, in the embodiment of FIG. 3B, enterprise E1 is associated with OTT messaging channel names OTTx and OTTy, and enterprise E2 is associated with OTT messaging channel names OTTx and OTTy. To connect to enterprise E1 via OTT messaging channel OTTx, the multi-tenant system uses OTT connection parameter UsernameX. To connect to enterprise E1 via OTT messaging channel OTTy, the multi-tenant system uses OTT connection parameter PhoneNumberX.

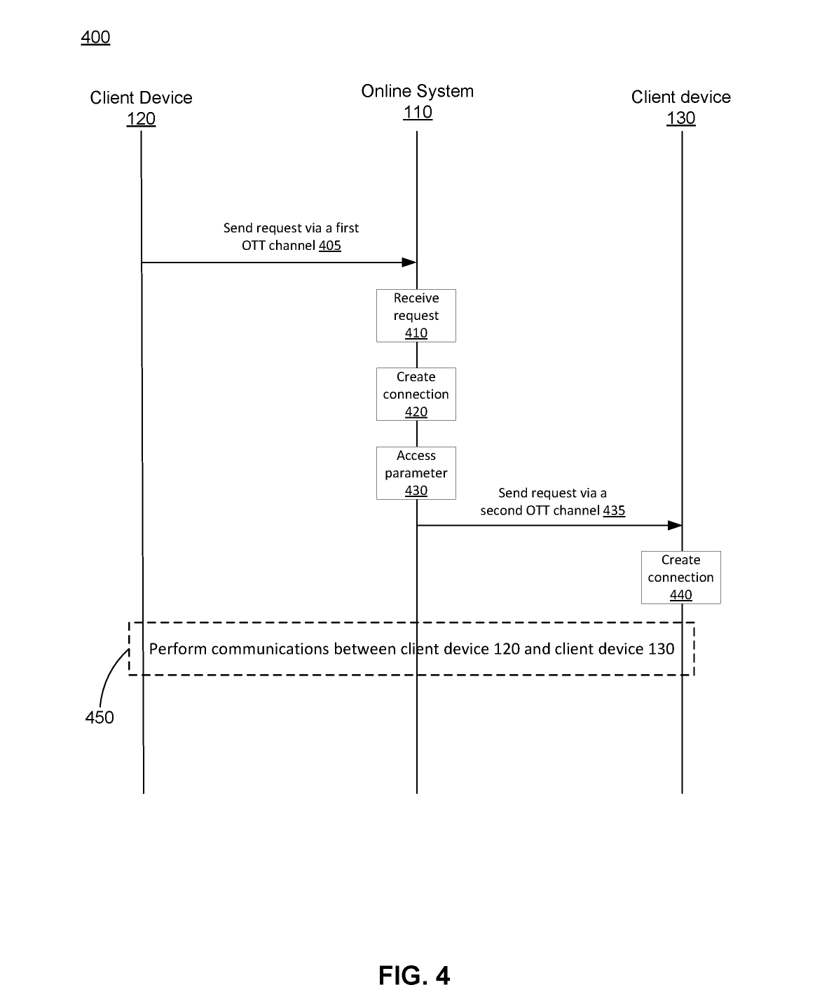

FIG. 4 is a flowchart illustrating a method for establishing a connection between a first client device and a second client device using OTT messaging channels, in accordance with an embodiment.

The client device 120 sends 405 a request to the online system 110. The online system 110 receives 410 the request from a first client device 120 via a first OTT channel. The request includes an identifier associated with an entity associated with the client device 130, for example, a user or an enterprise. In an embodiment, the online system 110 is a multi-tenant system and the entity associated with the client device 130 is an enterprise that is a tenant of the multi-tenant system and the request includes an enterprise system identifier (ID) for the enterprise. In another embodiment, the entity associated with the client device 130 is a user and the request includes an identifier (ID) for the user.

The online system 110 creates 420 a first connection via the first OTT messaging channel with the first client device 120. More specifically, a connection module of the online system 110 creates the first connection via the first OTT messaging channel with the first client device 120.

The online system 110 accesses 430 a set of connection parameters for a second OTT messaging channel, the set of connection parameters associated with the entity associated with the client device 130. In the embodiment in which the online system is a multi-tenant system, the entity is an enterprise and the set of connection parameters associated with the enterprise system 135 are stored in the enterprise metadata store 220 of the multi-tenant system.

The online system 110 use the set of connection parameters to create 440 a second connection via the second OTT messaging channel with a second client device associated with the enterprise system.

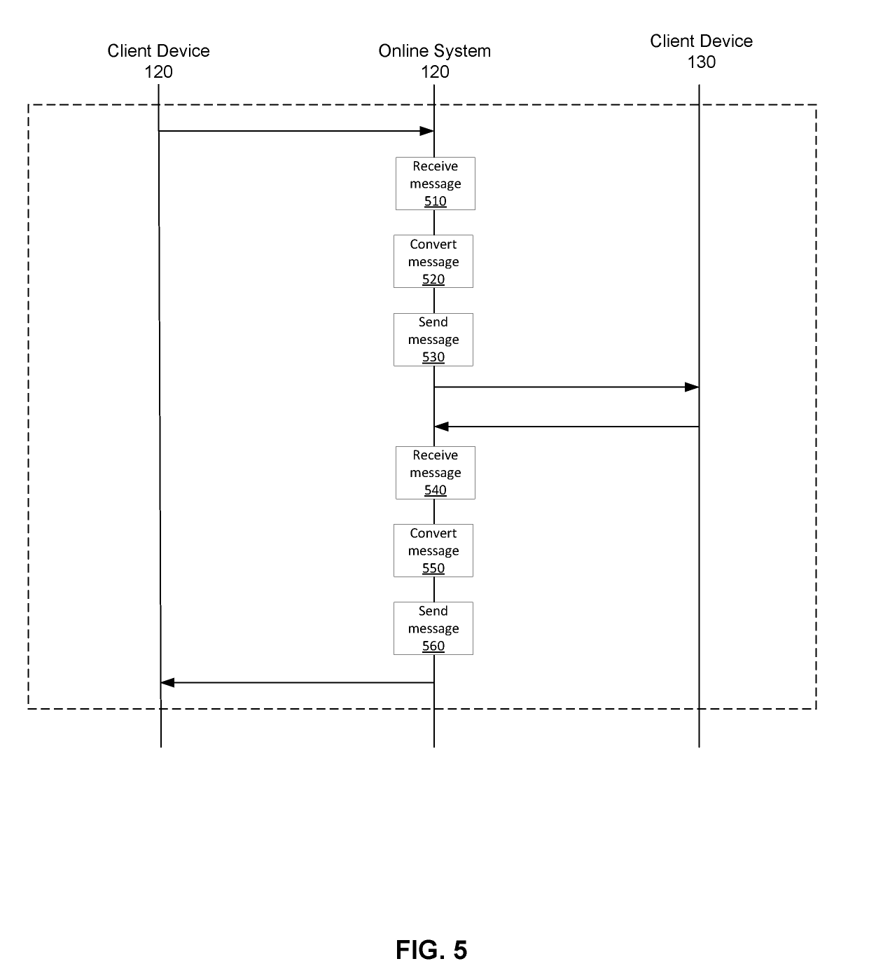

The multi-tenant system performs 450 communications between the first client device and the second client device as described in connection with FIG. 5.

FIG. 5 is a flowchart illustrating a method for communication between a first client device and a second client device using OTT messaging channels, in accordance with an embodiment. The following steps 510, 520, 530, 540, 550, and 560 are repeated. The online system 110 receives 510 a first message from the first client device 120 via the first OTT messaging channel. The online system 110 converts 520 the first message to a message conforming to the second OTT messaging channel. The online system 110 sends 530 the converted first message via the second OTT messaging channel to the second client device 130. The online system 110 receives 540 a second message from the second client device 130 via the second OTT messaging channel. The online system 110 converts 550 the second message to a message conforming to the first OTT messaging channel. The online system 110 sends 560 the converted second message via the first OTT messaging channel to the first client device 120.

The online system 110 converts a message M1 received via a first OTT messaging channel C1 to a message M2 for sending via a second OTT messaging channel C2 by converting the format of the data of the message M1 from a format of channel C1 to a format of channel C2. The online system 110 may replace metadata stored in message M1 that conforms to channel C1 to metadata conforming to channel C2. The online system 110 receives the message M1 using communication protocols of channel C1 but sends the message M2 by using protocols of channel C2. In an embodiment, the two messaging channels used by the two client devices can use different media types, for example, a first messaging channel may use text and another messaging channel may user audio or video. Alternatively, one messaging channel may use audio and another may use video, and so on.

In one embodiment, one of the client devices, for example, client device 130 executes a non-OTT client application that uses a non-OTT messaging channel. For example, assume that client device 120 executes an OTT messaging channel Cx and the client device 130 uses a non-OTT messaging channel Cy. The online system 110 receives 510 a first message from the first client device 120 via the OTT messaging channel Cx. The online system 110 converts 520 the first message to a message conforming to the non-OTT messaging channel Cy. The online system 110 sends 530 the converted first message via the non-OTT messaging channel Cy to the second client device 130. The online system 110 receives 540 a second message from the second client device 130 via the non-OTT messaging channel Cy. The online system 110 converts 550 the second message to a message conforming to the OTT messaging channel Cx. The online system 110 sends 560 the converted second message via the OTT messaging channel Cx to the first client device 120.

The online system 110 converts a message Mx received the OTT messaging channel Cx to a message My for sending via the non-OTT messaging channel Cy by converting the format of the data of the message Mx from a format of channel Cx to a format of channel Cy. The online system 110 may replace metadata stored in message Mx that conforms to channel Cx to metadata conforming to channel Cy. The online system 110 receives the message M1 using communication protocols of channel Cx but sends the message M2 by using protocols of channel Cy.

In some embodiments, the online system 110 receives a request from the second device 130 to switch from the second OTT messaging channel to a third OTT messaging channel. The online system 110 access a set of connection parameters for a third OTT messaging channel, the second set of connection parameters associated with the enterprise. The online system 110 creates a third connection via the third OTT messaging channel with the second client device, the third connection for use in communicating with the first client device via the online system 110. Responsive to creating the third connection, performing communications between the first client device and the second client device includes, repeating one or more times, receiving a third message from the first client device via the first OTT messaging channel, converting the third message to a message conforming with the third OTT messaging channel, sending the converted third message via the third OTT messaging channel to the second client device, receiving a fourth message from the second client device via the third OTT messaging channel, converting the fourth message to a message conforming with the first OTT messaging channel, and sending the converted fourth message via the first OTT messaging channel to the first client device.

In some embodiments, the online system 110 is a multi-tenant system that dynamically selects a client device 130 to connect with the client device 120. For example, the multi-tenant system stores a set of currently available agents of the enterprise. The set of currently available agents of the enterprise dynamically changes, for example, as agents become busy or available or leave their shift. The multi-tenant system dynamically identifies an agent of the enterprise that is currently available and selects the client device 130 as the client device of the available agent. Accordingly, the client device 130 as well as the user of the client device 130 is dynamically determined by the online system 110. The online system 110 may connect the client device 120 with a different client device 130 and a different user if the client device 120 made a second request for communication via the first OTT messaging channel. Furthermore, the online system 110 may connect with the client device 130 using two different OTT messaging channels at two different time (while establishing a connection between client devices 120 and 130) even though the client device 120 sends 405 an identical request at two different time.

In some embodiments, the online system 110 may switch the client device 130 during the same session established by client device 120. Accordingly, the online system 110 may select a different client device 130 during an ongoing session and create a new connection with the new client device 130. The online system 130 continues converting messages between the client device 120 and the new client device 130. The switch is seamless with respect to the client device 120. The online system may use different OTT messaging channels for communicating with the previous client device 130 as compared to the new client device 130. In an embodiment, the online system may switch one of the client devices using an OTT messaging channel to start using a non-OTT messaging channel during an ongoing session. Alternatively, the online system may switch one of the client devices using a non-OTT messaging channel to start using an OTT messaging channel during an ongoing session.

### Computer Architecture

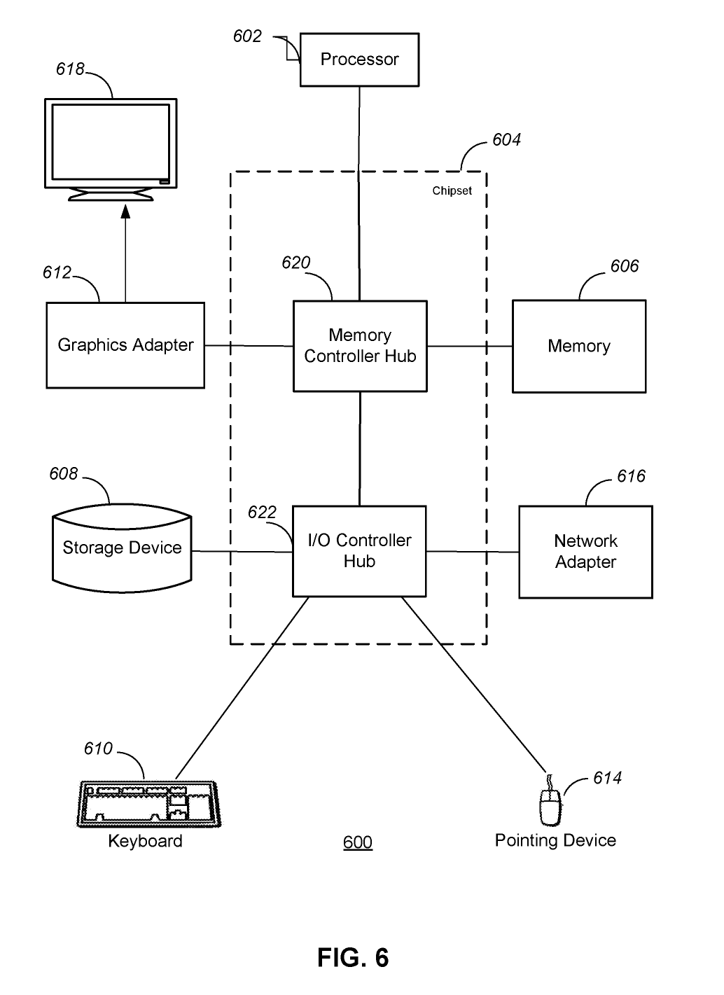

FIG. 6 is a high-level block diagram illustrating an example computer for implementing the client device and/or the multi-tenant system or online system of FIG. 1, according to an embodiment. The computer 600 includes at least one processor 602 coupled to a chipset 604. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, an input device 614, and network adapter 616 are coupled to the I/O controller hub 622. Other embodiments of the computer 600 have different architectures.

The storage device 608 is a non-transitory computer-readable storage medium such as a hard drive, compact disk read-only memory (CD-ROM), DVD, or a solid-state memory device. The memory 606 holds instructions and data used by the processor 602. The input interface 614 is a touch-screen interface, a mouse, track ball, or other type of pointing device, a keyboard, or some combination thereof, and is used to input data into the computer 600. In some embodiments, the computer 600 may be configured to receive input (e.g., commands) from the input interface 614 via gestures from the user. The graphics adapter 612 displays images and other information on the display 618. The network adapter 616 couples the computer 600 to one or more computer networks.

The computer 600 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 608, loaded into the memory 606, and executed by the processor 602.

The types of computers 600 used by the entities of FIG. 1 can vary depending upon the embodiment and the processing power required by the entity. The computers 600 can lack some of the components described above, such as graphics adapters 612, and displays 618. For example, the online system 110 or the enterprise system 135 can be formed of multiple blade servers communicating through a network such as in a server farm.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, by a multi-tenant system, a request from a first client device via a first over-the-top (OTT) channel, the request comprising an enterprise system identifier (ID) for an enterprise that is a tenant of the multi-tenant system;
creating a first connection via the first OTT messaging channel with the first client device;
accessing, by the multi-tenant system, a set of connection parameters for a second OTT messaging channel, the set of connection parameters associated with the enterprise;
creating a second connection via the second OTT messaging channel with a second client device associated with the enterprise system; and
performing communications between the first client device and the second client device, the performing comprising:
receiving a first message from the first client device via the first OTT messaging channel;
converting the first message to a message conforming with the second OTT messaging channel;
sending the converted first message via the second OTT messaging channel to the second client device;
receiving a second message from the second client device via the second OTT messaging channel;
converting the second message to a message conforming with the first OTT messaging channel; and
sending the converted second message via the first OTT messaging channel to the first client device.

2. The method of claim 1 wherein the first client device is not directly coupled to the second client device via the first OTT messaging channel.

3. The method of claim 1, wherein the enterprise ID is one of a phone number, a unique identifier issued by the multi-tenant system, a unique name, or an address.

4. The method of claim 1, wherein the set of connection parameters is a first set of connection parameters, the method further comprising:
receiving, by the multi-tenant system, from the second client device, a request to switch from the second OTT messaging channel to a third OTT messaging channel;
accessing, by the multi-tenant system, a second set of connection parameters for a third OTT messaging channel, the second set of connection parameters associated with the enterprise;
creating a third connection via the third OTT messaging channel with the second client device, the third connection for use in communicating with the first client device via the online system.

5. The method of claim 4, further comprising:
responsive to creating the third connection, performing communications between the first client device and the second client device, comprising, repeating one or more times:
receiving a third message from the first client device via the first OTT messaging channel;
converting the third message to a message conforming with the third OTT messaging channel;
sending the converted third message via the third OTT messaging channel to the second client device;
receiving a fourth message from the second client device via the third OTT messaging channel;
converting the fourth message to a message conforming with the first OTT messaging channel; and
sending the converted fourth message via the first OTT messaging channel to the first client device.

6. The method of claim 1, wherein the first OTT messaging channel performs text based communications and the second OTT messaging channel performs voice based communications.

7. The method of claim 1, wherein the first OTT messaging channel performs text based communications and the second OTT messaging channel performs video based communications.

8. The method of claim 1, further comprising:
identifying by the multi-tenant system, an agent of the enterprise that is currently available; and
selecting the second client device as the client device of the available agent.

9. A method comprising:
receiving, by an online system, a request from a first client device via a first over-the-top (OTT) channel, the request comprising an identifier (ID) associated with a user of a second client device;
creating a first connection via the first OTT messaging channel with the first client device;
accessing, by the online system, a set of connection parameters for a second messaging channel, the set of connection parameters associated with the identifier;
creating a second connection via the second messaging channel with the second client device; and
performing communications between the first client device and the second client device, the performing comprising:
receiving a first message from the first client device via the first OTT messaging channel;
converting the first message to a message conforming with the second messaging channel;
sending the converted first message via the second messaging channel to the second client device;
receiving a second message from the second client device via the second messaging channel;
converting the second message to a message conforming with the first OTT messaging channel; and
sending the converted second message via the first OTT messaging channel to the first client device.

10. The method of claim 9, wherein the first client device is not directly coupled to the second client device via the first OTT messaging channel.

11. The method of claim 9, wherein the enterprise ID is one of a phone number, a unique identifier issued by the multi-tenant system, a unique name, or an address.

12. The method of claim 9, wherein the set of connection parameters is a first set of connection parameters, the method further comprising:
receiving, by the online system, from the second client device, a request to switch from the second messaging channel to a third OTT messaging channel;
accessing, by the online system, a second set of connection parameters for a third OTT messaging channel, the second set of connection parameters associated with the user;
creating a third connection via the third OTT messaging channel with the second client device, the third connection for use in communicating with the first client device via the online system.

13. The method of claim 12, further comprising:
responsive to creating the third connection, performing communications between the first client device and the second client device, comprising, repeating one or more times:
receiving a third message from the first client device via the first OTT messaging channel;
converting the third message to a message conforming with the third OTT messaging channel;
sending the converted third message via the third OTT messaging channel to the second client device;
receiving a fourth message from the second client device via the third OTT messaging channel;
converting the fourth message to a message conforming with the first OTT messaging channel; and
sending the converted fourth message via the first OTT messaging channel to the first client device.

14. The method of claim 13, wherein the second messaging channel is one of: an OTT messaging channel or a non-OTT messaging channel.

15. A non-transitory computer readable storage medium, storing instructions for:
receiving, by a multi-tenant system, a request from a first client device via a first over-the-top (OTT) channel, the request comprising an enterprise system identifier (ID) for an enterprise that is a tenant of the multi-tenant system;
creating a first connection via the first OTT messaging channel with the first client device;
accessing, by the multi-tenant system, a set of connection parameters for a second OTT messaging channel, the set of connection parameters associated with the enterprise;
creating a second connection via the second OTT messaging channel with a second client device associated with the enterprise system; and
performing communications between the first client device and the second client device, comprising, the performing comprising, repeating one or more times:
receiving a first message from the first client device via the first OTT messaging channel;
converting the first message to a message conforming with the second OTT messaging channel;
sending the converted first message via the second OTT messaging channel to the second client device;
receiving a second message from the second client device via the second OTT messaging channel;
converting the second message to a message conforming with the first OTT messaging channel; and
sending the converted second message via the first OTT messaging channel to the first client device.

16. The non-transitory computer readable storage medium of claim 15, wherein the first client device is not directly coupled to the second client device via the first OTT messaging channel.

17. The non-transitory computer readable storage medium of claim 15, wherein the enterprise ID is one of a phone number, a unique identifier issued by the multi-tenant system, a unique name, or an address.

18. The non-transitory computer readable storage medium of claim 15, wherein the set of connection parameters is a first set of connection parameters, the method further storing instructions for:
receiving, by the multi-tenant system, from the second client device, a request to switch from the second OTT messaging channel to a third OTT messaging channel;
accessing, by the multi-tenant system, a second set of connection parameters for a third OTT messaging channel, the second set of connection parameters associated with the enterprise;
creating a third connection via the third OTT messaging channel with the second client device, the third connection for use in communicating with the first client device via the online system.

19. The non-transitory computer readable storage medium of claim 18, further storing instructions for:
responsive to creating the third connection, performing communications between the first client device and the second client device, comprising, repeating one or more times:
receiving a third message from the first client device via the first OTT messaging channel;
converting the third message to a message conforming with the third OTT messaging channel;
sending the converted third message via the third OTT messaging channel to the second client device;
receiving a fourth message from the second client device via the third OTT messaging channel;
converting the fourth message to a message conforming with the first OTT messaging channel; and
sending the converted fourth message via the first OTT messaging channel to the first client device.

20. The non-transitory computer readable storage medium of claim 15, further storing instructions for:
identifying by the multi-tenant system, an agent of the enterprise that is currently available; and
selecting the second client device as the client device of the available agent.
